(19) United States
(12) Patent Application Publication
(10) Pub. No.: US 2018/0218636 A1
(43) Pub. Date: Aug. 2, 2018

(54) PICTOGRAPH DISPLAY DEVICE TO REPRESENT TIME

(71) Applicant: JOY S.A.S., San Francisco, CA (US)

(72) Inventors: Omar Alaouf, Wichita, KS (US); Samuel Hickmann, San Francisco, CA (US)

(21) Appl. No.: 15/881,173

(22) Filed: Jan. 26, 2018

Related U.S. Application Data
(60) Provisional application No. 62/451,275, filed on Jan. 27, 2017.

(51) Int. Cl. G09B 19/00; H04L 29/08; G06F 3/0484; G09B 5/02; G04G 9/00; G04G 21/04; G04G 19/00

(52) U.S. Cl. CPC G09B 19/003; H04L 67/26; G06F 3/04842; G09B 19/0084; G06F 3/02; G04G 9/0064; G04G 21/04; G04G 19/00; G09B 5/02

(57) ABSTRACT

Introduced here is a technology to help a child's caregiver develop good daily habits in the child by providing a method to keep track of time that the young child can understand. In one embodiment, the child carries a smart watch on the wrist, which displays upcoming tasks using easy to understand pictographs. The smart watch is wirelessly connected to the smart phone of the caregiver. The caregiver can program the smart phone to send a particular pictograph at a particular time to the child's watch to remind the child of the upcoming task. For example, when time comes to brush teeth, the smart watch can display a picture of the toothbrush.

### CROSS REFERENCE TO RELATED APPLICATION

This application is non-provisional of U.S. Provisional Application No. 62/451,275, filed Jan. 27, 2017, the disclosure of which is incorporated by reference in its entirety.

### TECHNICAL FIELD

The present application is related to a pictograph display devices, and more specifically to methods and systems that represent time using the pictograph display.

### BACKGROUND

Young children have a hard time keeping track of time of day in part because they do not understand clocks, and cannot read them. Developing good daily habits in young children is left to constant reminders of the child's caregivers. The nagging reminders can quickly devolve into power struggles between the child and the caregiver.

### SUMMARY

Introduced here is a technology to help a child's caregiver develop good daily habits in the child by providing a method to keep track of time that the young child can understand. In one embodiment, the child carries a smart watch on the wrist, which displays upcoming tasks using easy to understand pictographs. The smart watch is wirelessly connected to the smart phone of the caregiver. The caregiver can program the smart phone to send a particular pictograph at a particular time to the child's watch to remind the child of the upcoming task. For example, when time comes to brush teeth, the smart watch can display a picture of the toothbrush.

In one embodiment, A wearable electronic device is provide that can include communications circuitry, memory storage comprising a plurality of pictograms and a schedule organized according to a plurality of activity specific time frames, wherein each of the pictograms corresponds to a particular one of the plurality of activity specific time frames, a clock, a display screen, and a processor coupled to the communications circuitry, memory storage, clock, and the display screen. The processor is operative to monitor the clock for a time, compare the time to the schedule to determine which one of the activity specific time frames is currently active, and display, on the display screen, the time and the pictogram that corresponds to the activity specific time frame determined to be currently active.

In another embodiment, an electronic device is provided that includes communications circuitry operative to wirelessly communicate with a wearable electronic device, an interactive display screen, and a processor coupled to the interactive display screen and the communications circuitry. The processor is operative to manage presentation of pictographs to be displayed on the wearable electronic device. For each pictograph to be displayed on the wearable device, the processor is further operative to receive a user selection of a picture, and receive a start time and an end time to define an activity specific time frame corresponding to the picture, wherein the activity specific time frame corresponding to the picture of each pictograph specifies when the picture should be displayed on the wearable electronic device. The processor is operative to transmit the picture of each pictograph to the wearable electronic device via the communications circuitry.

### BRIEF DESCRIPTION OF THE DRAWINGS

FIG. 1A shows various pictographs representing various times on a smart watch display.

FIG. 1B shows various display modes of the smart watch.

FIG. 2 shows how the smart watch communicates with a computing device.

FIG. 3 shows how multiple smart watches communicate with multiple computing devices.

FIG. 4A shows the steps to create a pictograph and synchronize the pictograph to the watch.

FIG. 4B shows a task reminder displayed on a computing device.

FIG. 5 shows a graphical user interface to manage multiple smart watches from a single computing device.

FIG. 6 shows a graphical user interface tracking successful completion of the tasks and rewarding the child for successfully completed tasks.

FIG. 7 shows a smart watch attached to a charging station.

FIG. 8 shows the back of a smart watch.

FIG. 9 shows a nightlight without a smart watch.

FIG. 10 shows a pictograph display device, according to one embodiment.

FIG. 11 is a diagrammatic representation of a machine in the example form of a computer system within which a set of instructions, for causing the machine to perform any one or more of the methodologies or modules discussed herein, may be executed.

### DETAILED DESCRIPTION

### Pictograph Display Device

Introduced here is a technology to help a child's caregiver develop good daily habits in the child by providing a method to keep track of time that the young child can understand. In one embodiment, the child carries a smart watch on the wrist, which displays upcoming tasks using easy to understand pictographs. The smart watch is wirelessly connected to the smart phone of the caregiver. The caregiver can program the smart phone to send a particular pictograph at a particular time to the child's watch to remind the child of the upcoming task. For example, when time comes to brush teeth, the smart watch can display a picture of the toothbrush.

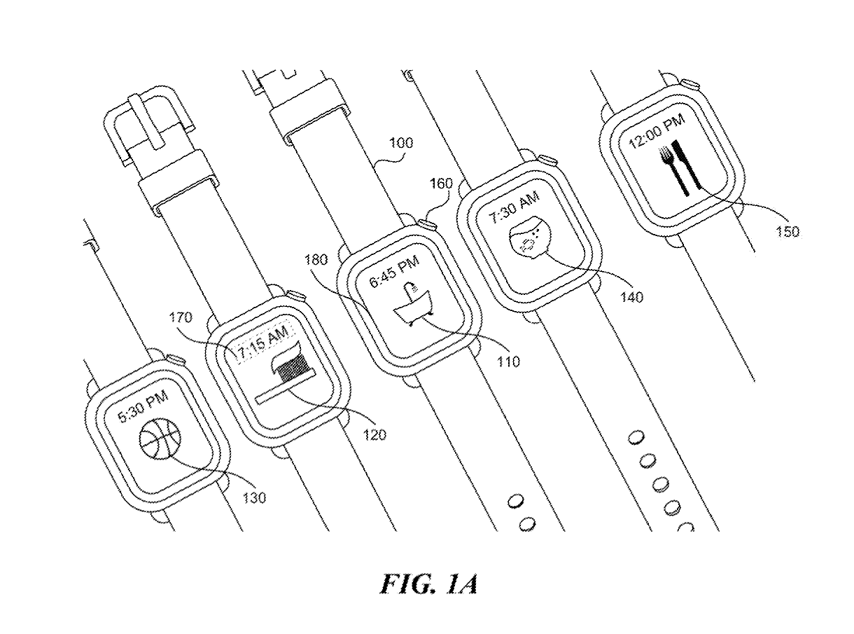

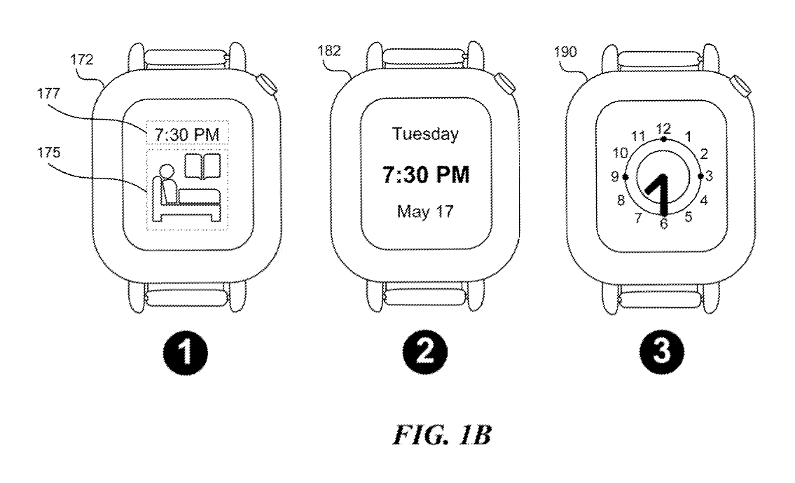

FIG. 1A shows various pictographs representing various times on a smart watch display. The smart watch 100 includes a display 180 which can show various pictographs 110, 120, 130, 140, 150, representing a task due. The smart watch 100 can optionally include the time 170 in addition to the pictograph 110, 120, 130, 140, 150. Further, the smart watch 100 can gently vibrate upon displaying the pictograph 110, 120, 130, 140, 150, to remind the child that a task is due. The pictographs are self-explanatory and communicate the task that needs to be done to a child, without a need for the child to read. The smart watch 100 can include a button 160, which when pressed indicates that the child has completed the task. Button 160 may be mechanical depressible button or a capacitive button. In some embodiments, smart watch 100 can be devoid of buttons altogether and the user of watch 160 may interact with the watch via a touchscreen interface aligned with display 180.

A set of pre-loaded pictographs comes with the smart watch 100. However, the smart watch 100 can receive customized pictographs from a remote computing device. Upon receiving the pictographs 110, 120, 130, 140, 150, and information associated with the pictographs 110, 120, 130, 140, 150 (such as when to display the pictograph) the smart watch 100 can store the received information within a memory inside the smart watch 100. The smart watch 100 can provide templates for routines based on age and gender of the child. The templates can be adjusted, or new ones can be created. Certain features are unlocked based on the age of the child, such as new clock faces.

The remote computing device is associated with the child caregiver, such as a parent, a guardian, or a teacher. At the time when the smart watch displays the pictograph, the remote computing the device can also display the pictograph to the caregiver, to remind the caregiver of the child's upcoming task.

FIG. 1B shows various display modes of the smart watch. The first mode 172 helps a child understand time by association. The first mode 172 displays both the pictograph 175 and a digital time 177, and helps the child to associate the time 177 with the pictograph 175. The second mode 182 helps the child to learn to read a digital clock by displaying a digital time. The third mode 190 help this child to read an analog clock by displaying an analog time.

The pictograms may be tied to a schedule that controls when each pictogram is to be displayed on the smart watch. The schedule may be organized according to several activity specific time frames, where each pictogram corresponds to a particular one of the activity specific time frames. Each activity specific time frame may have a start time and an end time (e.g., that may be set by the caretaker or parent). In embodiments where the smart watch stores preloaded pictograms and a schedule, the smart watch may monitor a clock for a time, compare the time to the schedule to determine which one of the activity specific time frames is currently active, and display, on the display screen, the time and the pictogram that corresponds to the activity specific time frame determined to be currently active. In some embodiments, the watch may receive an update the schedule that pertains to at least one pictogram. The schedule may allow for extra time in the form of a temporary adjustment for the user of the watch to complete the task corresponding to the activity specific time frame that has been temporarily adjusted.

The smart watch may record in a log whether an activity corresponding to the activity specific time frame determined to be currently active is performed or not. The log may be stored in the memory of the watch. The log may be transmitted to another device, such as, for example, a smart phone that is wirelessly connected to the watch. A user of the watch may press a button or interact with some other type of input to confirm that the activity was performed.

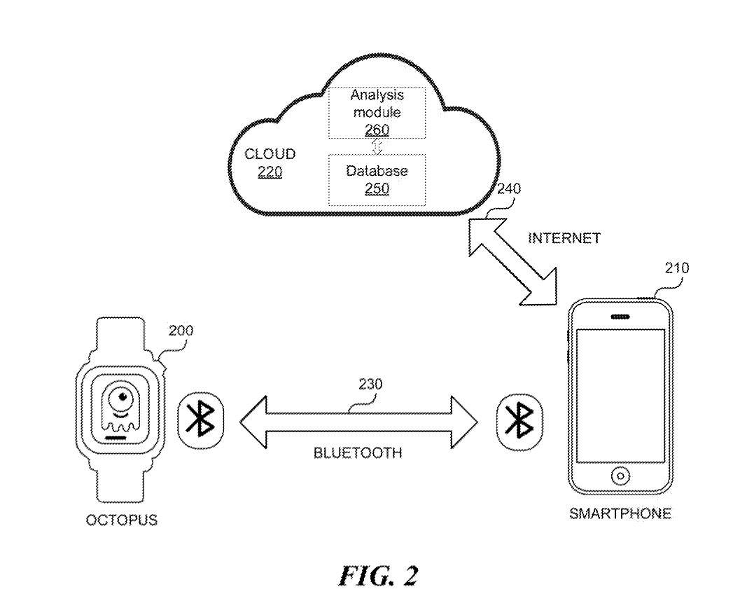

FIG. 2 shows how the smart watch communicates with a computing device. The smart watch 200 can only communicate with a computing device 210 using a wireless network 230 such as Bluetooth. The smart watch 200 is disabled from communicating with the server 220 to limit the child's autonomous access to the Internet for safety and educational reasons. Computing device 210 can be a mobile device such as a cell phone, a desktop computer, laptop computer, a personal digital assistant, etc. The smart phone 210, in turn, can communicate with a server 220, such as a cloud server over the Internet, using wireless communication 240 such as cellular data network, Wi-Fi, etc.

The server 220 contains a database 250, which is a backup of all information stored on the smart watch 200, and the computing device 210. For example, the database 250 stores the pictographs, and the time the pictographs are displayed on the smart watch 200. Further, the database 250 can store information regarding interactions between the smart watch 200 and the computing device 210, and the daily routine associated with the two devices 200, 210. For example, the database 250 can store information regarding proximity of the two devices 200, 210, and the times of day when the two devices 200, 210 are proximate to each other. The information stored in the database 250 can be encrypted for security reasons.

An analysis module 260 running on the server 220, gathers information stored in the database 250, and looks for patterns in the information. The analysis module 260 can be an artificial intelligence software and/or hardware, such as a neural network. For example, the analysis module 260 can notice that if a task is postponed for 10 minutes, the child performs the task more efficiently, or begins performing the task more promptly. Consequently, the analysis module 260 can send a notification to the computing device 210 proposing to postpone the task by 10 minutes. In another example, the analysis module 260 can detect some unusual patterns in the location of the smart watch 200, unusual patterns in completing a task, etc., and generate a notification to the computing device 210 alerting the caregiver about the unusual pattern.

By preloading various information on the smart watch 200, the use of network bandwidth of the wireless network 230 is minimized. The preloaded information includes pictographs, a time to show the pictograph, duration of the pictograph display, whether the watch should vibrate when the pictograph is displayed, whether the task is repeated, whether validation of task completion should be sent back to the computing device 210, etc. Using the preloaded information, the smart watch can autonomously display an appropriate pictograph at an appropriate time, without the need to communicate with the computing device 210, over the wireless network 230. Only the updates to the preloaded information, such as new pictographs, can be sent over the network 230.

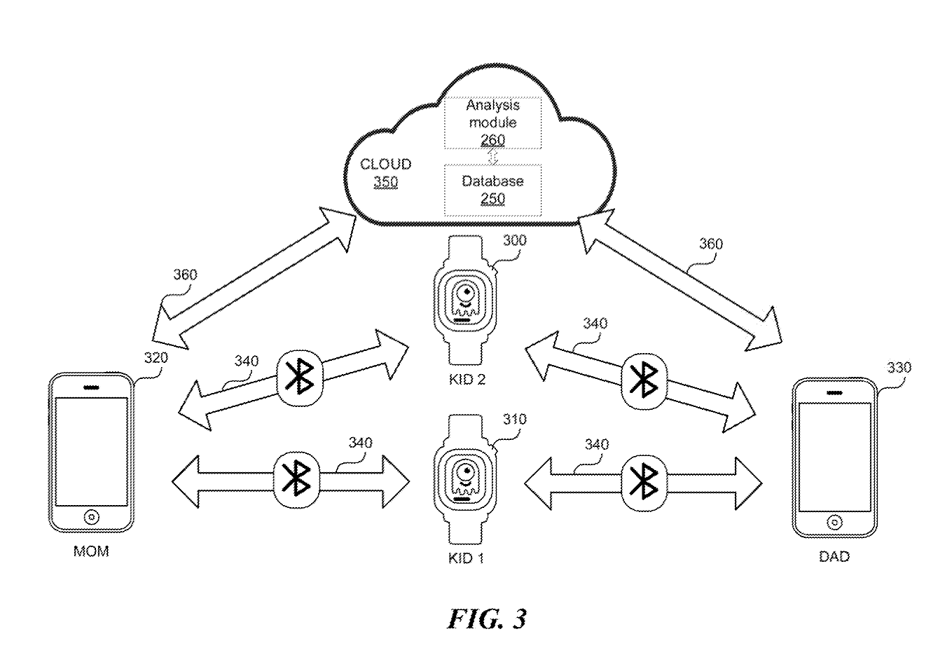

FIG. 3 shows how multiple smart watches communicate with multiple computing devices. Each of the smart watches 300, 310 can communicate with multiple computing devices 320, 330 using a wireless network 340, such as a Bluetooth. The smart watches 300, 310 are disabled for communicating with the server 350 for safety and educational reasons, as described above. Both of the computing devices 320, 330 can independently communicate with the server 350, using wireless communication 360 such as cellular data network, Wi-Fi, etc. The server 350 can be a desktop computer, a cloud server, etc. The server 350 can include the database 250 and the analysis module 260.

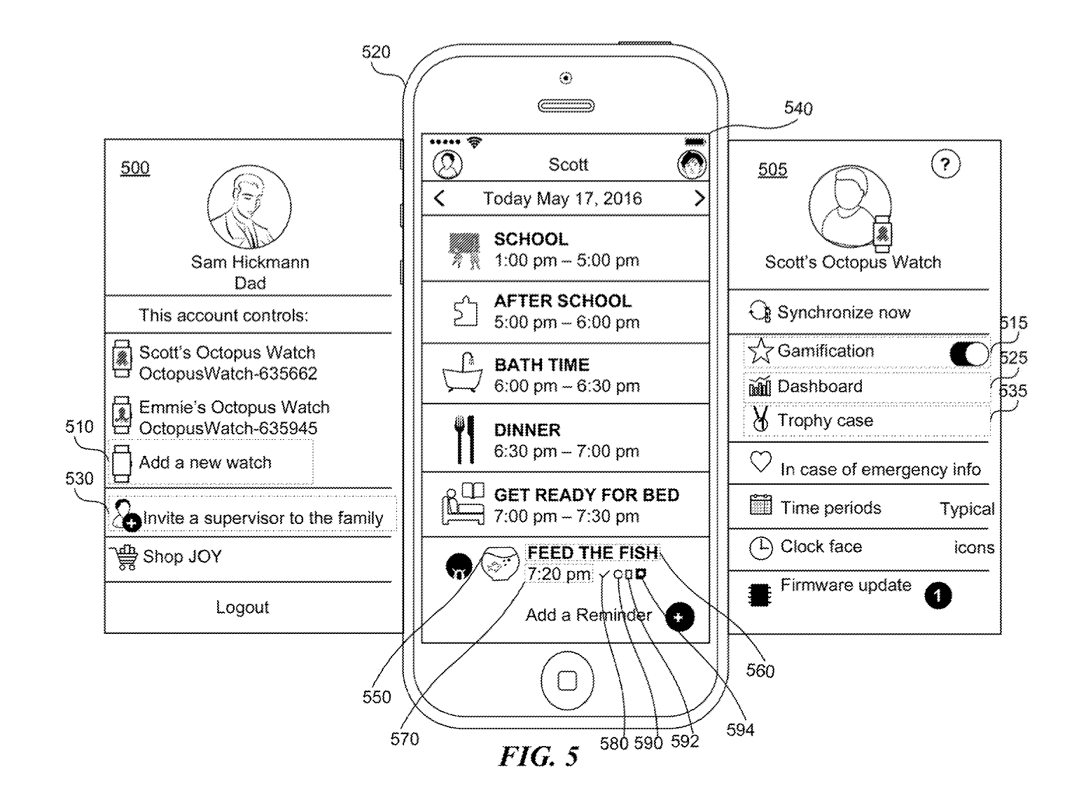

Further, the smart watch 200 in FIG. 2, 300, 310 in FIG. 3 is disabled from communicating with an unauthorized account. Only an authorized account can communicate with the smart watch 200, 300, 310. The smart watch 200, 300, 310 stores in memory of the smart watch, a list of authorized accounts, such as a caregiver account 530 in FIG. 5, that can communicate with the smart watch 200, 300, 310. To determine whether an account logged into the device attempting a wireless connection with the smart watch 200, 300, 310 is an authorized account, the smart watch 200, 300, 310 requests the account information from the device. If the received account information from the device does not match an entry in the list of authorized accounts, the smart watch 200, 300, 310 stops further communication with the account logged into the device. The advantage of allowing access to an authorized account, as opposed to an authorized device, is that even if the caregiver's device is stolen, the caregiver can buy a new device, log into the authorized account, and still have access to the smart watch 200, 300, 310.

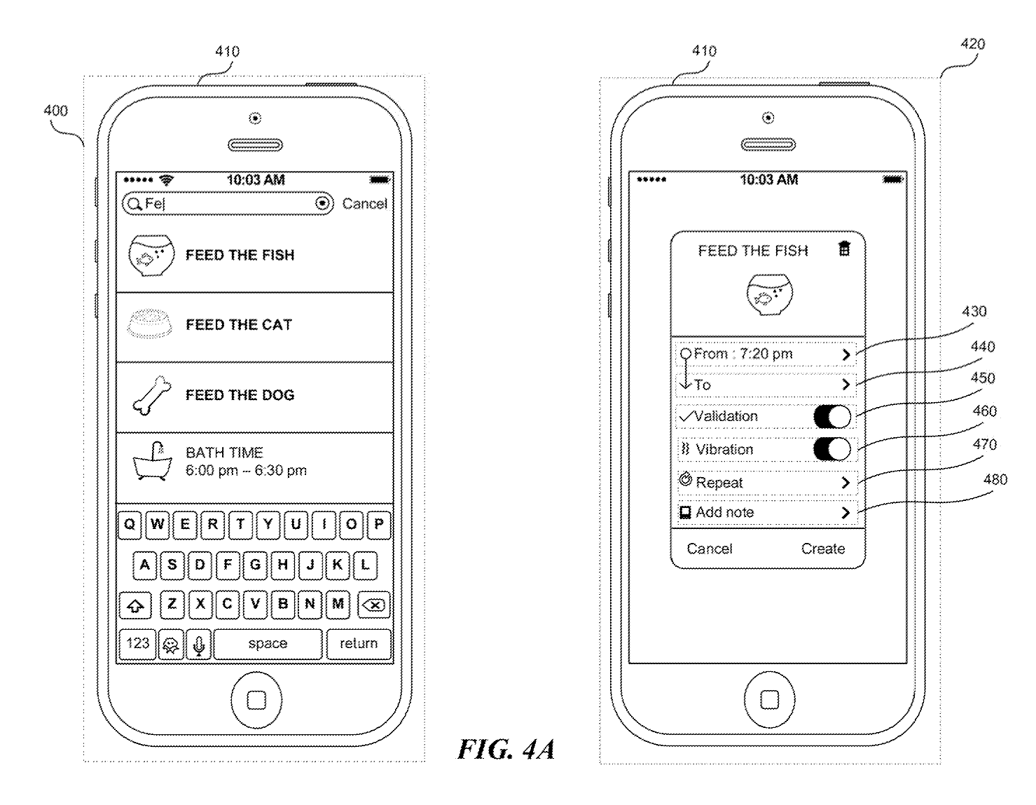

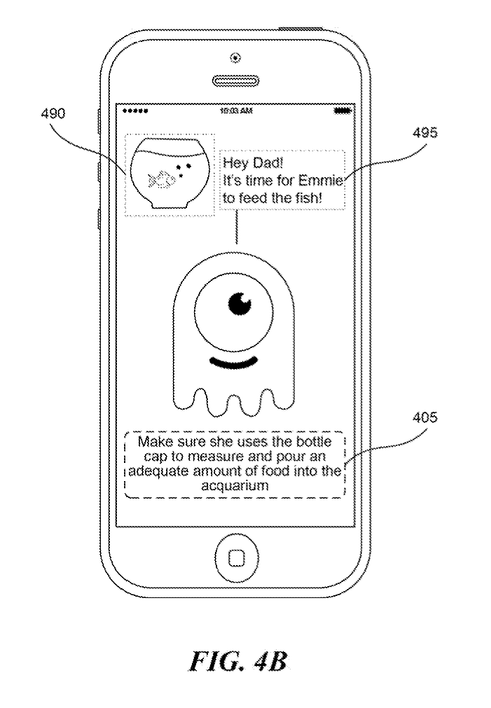

FIG. 4A shows the steps to create a pictograph and synchronize the pictograph to the watch. In step 400, the computing device 410 associated with a caregiver, receives the selection of a pictograph. In step 420, the computing device 410 receives information regarding the upcoming task. Graphical user interface (GUI) item 430 receives information about a time at which to send the pictograph to a smart watch. GUI item 440, optionally, receives information about how long to display the pictograph. GUI item 450 receives information about whether to require a validation of the completed task. GUI item 460 receives information about whether the smart watch should vibrate when the pictograph is received. GUI item 470 receives information about whether and when to repeat sending of the pictograph. GUI item 480 receives textual information that can be sent to the smart watch along with the pictograph, or that can be displayed on the computing device 410.

FIG. 4B shows a task reminder displayed on a computing device. The task reminder displayed on the computing device shows the pictograph 490 displayed simultaneously on a smart watch, a text 495 showing which smart watch is displaying the pictograph 490, and what the pictograph means. Additionally, the task reminder can display a note 405 to remind the parent what to pay attention to when supervising the child executing the task. For example, the note can say “make sure that Emmie uses the bottle cap to measure and pour an adequate amount of food into the aquarium”.

FIG. 5 shows a graphical user interface to manage multiple smart watches from a single computing device. The computing device 520 associated with the caregiver displays a graphical user interface 500, 505, 540, and allows the caregiver to add additional smart watches by selecting GUI item 510. The computing device 520 can send pictographs to all the added smart watches.

In addition, when the computing device 520 receives the selection of item 530, a new caregiver account is created in system. The new caregiver can independently send pictographs to all the smart watches added to the new caregiver account.

A graphical user interface 540 of the computing device 520 can display all the pictographs 550 (only one labeled for brevity) associated with a smart watch. In addition to displaying a pictograph 550, the smart watch can display textual explanation 560 of each pictograph, a time 570 when the pictograph 550 is displayed on the smart watch, whether validation of task completion 580 is acquired from the smart watch, whether the task is repeated 590, whether the smart watch vibrates 592 when the pictograph 550 is displayed, whether a note 594 is associated with the pictograph, etc.

A graphical user interface 505 shows global settings associated with the smart watch. Selection of item 515 turns on gamification feature of the smart watch. When the gamification feature is enabled, the computing device 520 of the caregiver tracks successful completion of the tasks, and awards virtual trophies to the child. Selection of item 525 displays a dashboard, while selection of item 535 displays the virtual trophy case.

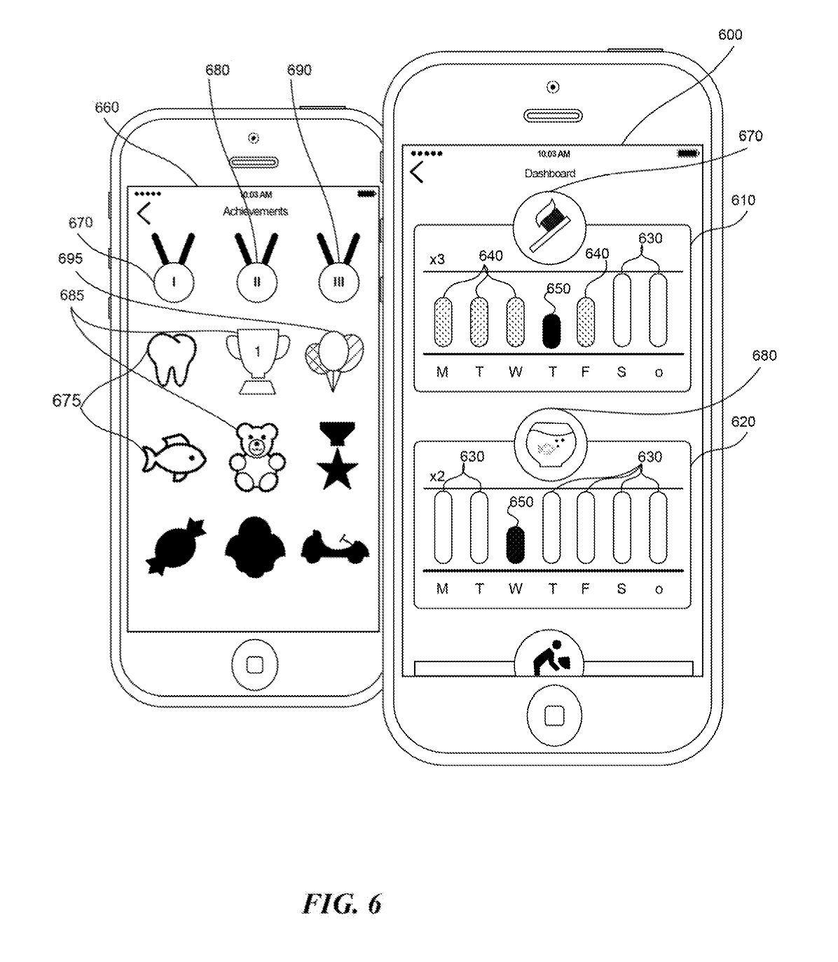

FIG. 6 shows a graphical user interface tracking successful completion of the tasks and rewarding the child for successfully completed tasks. The graphical user interface includes a dashboard 600 and a virtual trophy case 660.

The dashboard 600 shows a graph 610, 620 of successfully completed tasks. The X axis of the graph 610, 620 represents time, such as days of the week, weeks, months, etc. The Y axis of the graph 610, 620 represents percentage of the tasks successfully completed. Each graph 610, 620 corresponds to a single pictograph, i.e. a single task. The graph 610, 620 can be a bar graph, and can be color-coded indicating whether the child has successfully completed all the tasks, indicated in green 630, most of the tasks, indicated in yellow 640, or very few of the tasks, indicated in red 650.

Additionally, the dashboard can display an overall level of success for a given task. For example, if the child completes most of the task for the given week, such as more than 80% of the task, the child gets a gold medal 680. In a more specific example, if the child feeds the fish 80% of the time that the child is supposed to, the child gets the gold medal 680. If the child completes an average number of task for the week, such as less than 80% but more than 40%, the child gets a silver medal 670. For example, if the child brushes his teeth between 80% and 40% of the time that the child supposed to brush his teeth, the child gets the silver medal 670.

The virtual trophy case 660 displays the gold medal 680, and below the gold medal 680, the pictographs 675 of all the tasks for which the child has earned the gold medal 680. The virtual trophy case 660 displays the silver medal 670, and below the silver metal the virtual trophy case 660 displays all the pictographs 685 of all the tasks for which the child has earned the silver medal 670. Similarly, a bronze medal 690 is followed by pictographs 695 of all the tasks for which the child has earned the bronze medal 690. The pictographs displayed in black, show the tasks for which the child has not earned a medal.

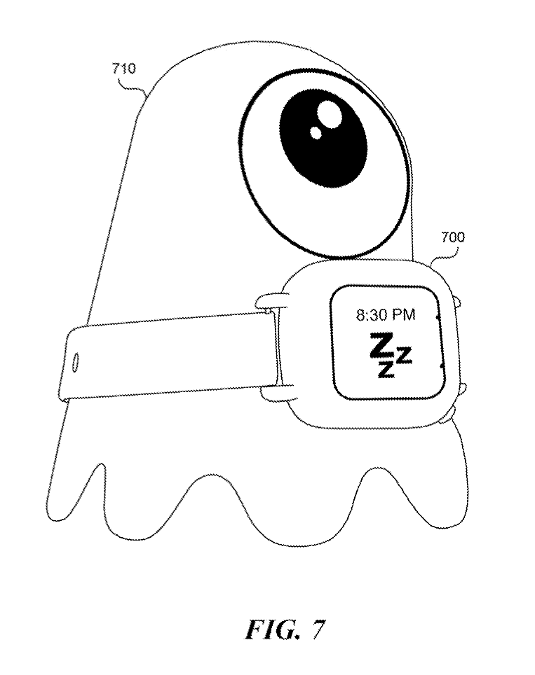

FIG. 7 shows a smart watch 700 attached to a charging station 710. The charging station 710 can also function as a nightlight. While attached, the smart watch 700 and the charging station 710 establish electrical contact, which allows the smart watch 700 to charge.

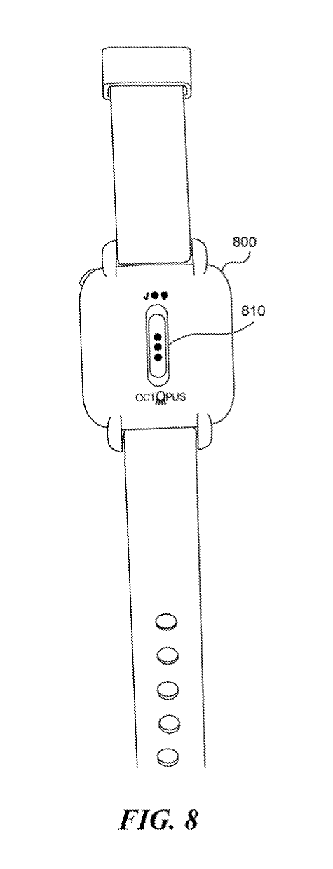

FIG. 8 shows the back of a smart watch. The smart watch 800 includes electrical contacts 810 on the back of the smart watch 800. The electrical contacts 810 come into contact with corresponding electrical contacts associated with a nightlight, when the smart watch 800 is mounted on the nightlight. In some embodiments, smart watch 800 may include at least one device magnet constructed to interface with at least one reciprocal magnet of the nightlight or charging station such that when the wearable electronic device is placed in proximity of the at least one reciprocal magnet, the at least one device magnet and the at least one reciprocal magnet align and connect the device power contracts 810 and the reciprocal power contacts (of the nightlight) together.

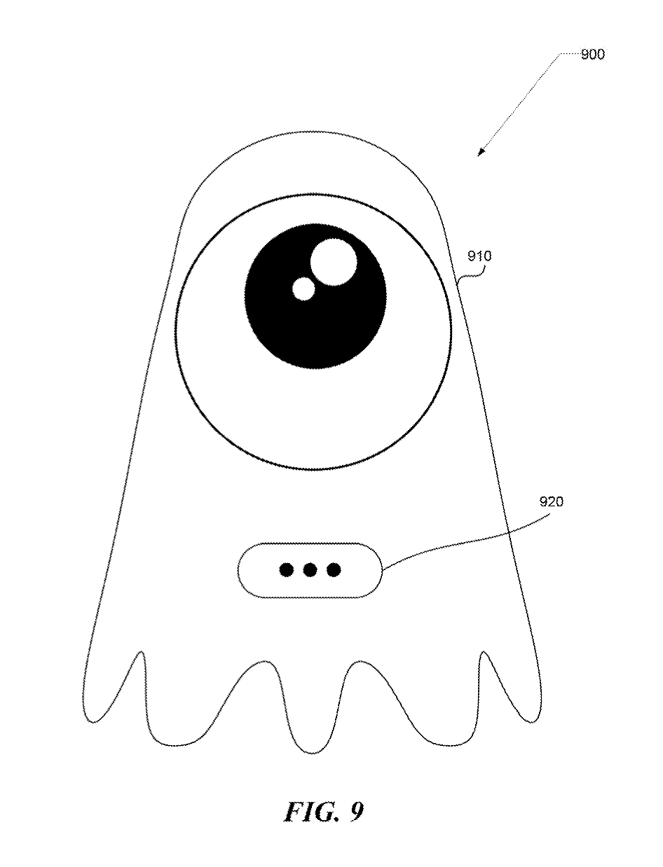

FIG. 9 shows a nightlight without a smart watch. The nightlight 900 contains a translucent shell 910, and electrical contacts 920. The shell 910 allows light emitted by a light source inside the shell 910 to gently glow through the shell's translucent material. The electrical contacts 920 correspond to the electrical contacts 810 on the back of the smart watch 800. When connected to power source, electrical contacts 920 provide current to the corresponding electrical contacts 810.

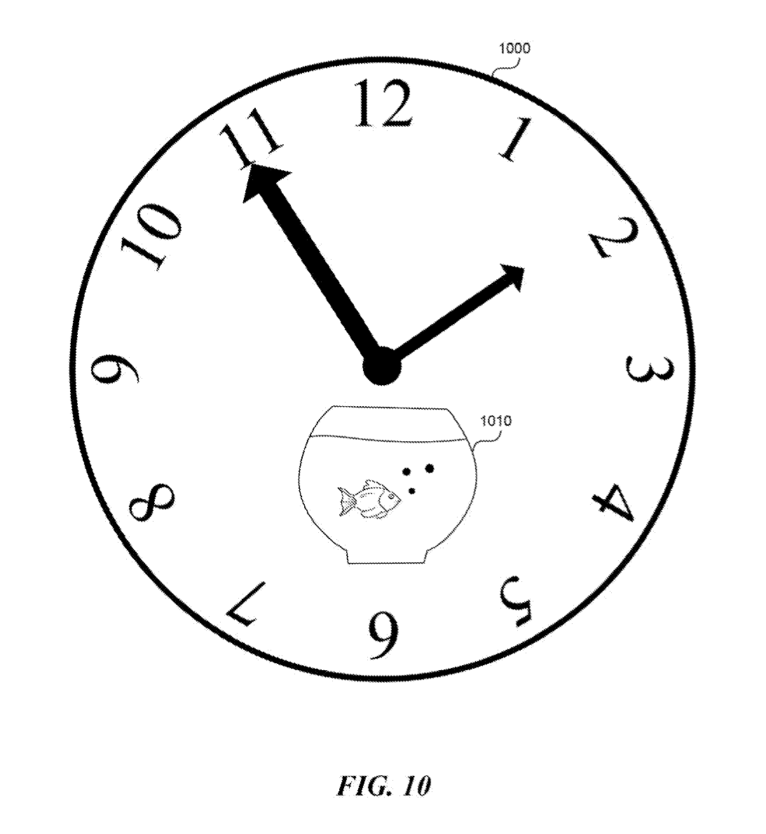

FIG. 10 shows a pictograph display device, according to one embodiment. The pictograph display device is a clock 1000 that can be viewed by multiple people, such as a wall-mounted clock, a set-top clock, etc. The pictograph display device 1000 displays the pictograph 1010. In another embodiment, instead of a clock, or a smart watch, the pictograph display device can be a small robot companion for a child. The small robot companion can verbally interact with the child, in addition to displaying the pictograph reminding the child of a task due.

### Computer

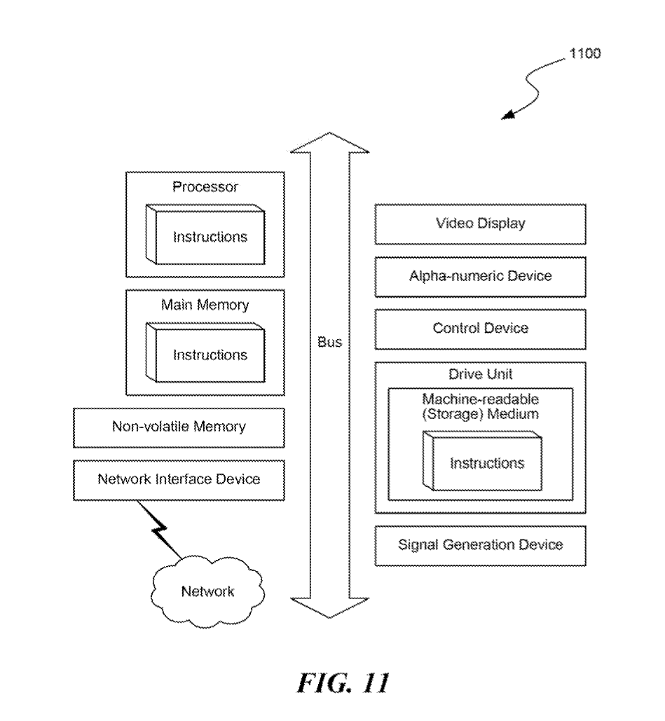

FIG. 11 is a diagrammatic representation of a machine in the example form of a computer system 1100 within which a set of instructions, for causing the machine to perform any one or more of the methodologies or modules discussed herein, may be executed.

The server 220 in FIG. 2, 350 in FIG. 3 can be the computer system 1100. The analysis module 260 in FIG. 2-3, can include instructions for running on the processor of the computer system 1100, or can include hardware that is part of the processor of the computer system 1100. The network interface device of the computer system 1100 can connect to the network 240 in FIG. 2, 360 in FIG. 3.

Additionally, the computing device 210 in FIG. 2, 320, 330 in FIG. 3, etc., can correspond to the computer system 1100. Video display of the computer system 1100 can display the graphical user interfaces described in the application.

Further, the smart watch 100 in FIG. 1, 200 in FIG. 2 300, 310 in FIG. 3 etc., can correspond to the computer system 1100. The display of the computer system 1100 can display the various pictographs such as 110, 120, 130, 140, 150 in FIG. 1, etc. The nonvolatile memory of the computer system 1100 can store the upcoming tasks for the child, and the pictographs associated with them.

In the example of FIG. 11, the computer system 1100 includes a processor, memory, non-volatile memory, and an interface device. Various common components (e.g., cache memory) are omitted for illustrative simplicity. The computer system 1100 is intended to illustrate a hardware device on which any of the components described in the example of FIGS. 1-10 (and any other components described in this specification) can be implemented. The computer system 1100 can be of any applicable known or convenient type. The components of the computer system 1100 can be coupled together via a bus or through some other known or convenient device.

This disclosure contemplates the computer system 1100 taking any suitable physical form. As example and not by way of limitation, computer system 1100 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 1100 may include one or more computer systems 1100; be unitary or distributed; span multiple locations; span multiple machines; or reside in a cloud, which may include one or more cloud components in one or more networks. Where appropriate, one or more computer systems 1100 may perform without substantial spatial or temporal limitation one or more steps of one or more methods described or illustrated herein. As an example and not by way of limitation, one or more computer systems 1100 may perform in real time or in batch mode one or more steps of one or more methods described or illustrated herein. One or more computer systems 1100 may perform at different times or at different locations one or more steps of one or more methods described or illustrated herein, where appropriate.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer 1100. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, storing and entire large program in memory may not even be possible. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system 1100. The interface can include an analog modem, isdn modem, cable modem, token ring interface, satellite transmission interface (e.g. “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 11 reside in the interface.

In operation, the computer system 1100 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

### REMARKS

The language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following claims.

What is claimed is:

1. A wearable electronic device, comprising:
communications circuitry;
memory storage comprising a plurality of pictograms and a schedule organized according to a plurality of activity specific time frames, wherein each of the pictograms corresponds to a particular one of the plurality of activity specific time frames;
a clock;
a display screen; and
a processor coupled to the communications circuitry, memory storage, clock, and the display screen, the processor operative to:
monitor the clock for a time;
compare the time to the schedule to determine which one of the activity specific time frames is currently active; and
display, on the display screen, the time and the pictogram that corresponds to the activity specific time frame determined to be currently active.

2. The device of claim 1, wherein the processor is further operative to:
record in a log, when an activity corresponding to the activity specific time frame determined to be currently active is performed, that the activity was performed; and
record in the log, when the activity corresponding to the activity specific time frame determined to be currently active is not performed, that the activity was not performed.

3. The device of claim 2, wherein the processor is further operative to:
transmit the log to a remote device via the communications circuitry.

4. The device of claim 1, wherein the processor is further operative to:
receive, via the communications circuitry, an update the to the schedule and at least one new pictogram; and
store the update to the schedule and the at least one new pictogram in the memory storage.

5. The device of claim 1, wherein the processor is further operative to:
receive, via the communications circuitry, a temporary adjustment to at least one of the plurality of activity specific time frames to provide additional time for a user of the wearable electronic device to complete an activity corresponding to the activity specific time frame that has been temporarily adjusted.

6. The device of claim 1, wherein the processor is further operative to:
when the time falls within a first one of the plurality of the activity specific time frames, display, on the display screen, the time and the pictogram that corresponds to the first one of the plurality of activity specific time frames; and
when the time falls within a second one of the plurality of the activity specific time frames, display, on the display screen, the time and the pictogram that corresponds to the second one of the plurality of activity specific time frames, wherein the second activity specific time frame follows the first activity specific time frame.

7. The device of claim 1, further comprising:
a housing;
a first strap attached to first side of the housing;
a second strap attached to a second side of the housing;
a button that is user activated; and
wherein the processor is operative to:
in response to a user activated press of the button, confirm that an activity corresponding to the activity specific time frame determined to be currently active has been performed.

8. The device of claim 1, wherein each of the plurality of pictographs are self-explanatory and communicate an activity that needs to be completed by a user of the wearable electronic device, without requiring that the user possess the ability to read.

9. The device of claim 1, further comprising:
a vibration member; and
wherein the processor is operative to:
cause the vibration member to vibrate in response to a transition from a first one of the plurality of activity specific time frames to a second one of the plurality of activity specific time frames; and
cause the vibration member to vibrate in response to a determination that an activity corresponding the activity specific time frame determined to be currently active has not yet been completed.

10. The device of claim 1, further comprising:
device power contacts constructed to interface with reciprocal power contacts of a charging station, wherein the charging station resembles an octopus.

11. An electronic device, comprising:
communications circuitry operative to wirelessly communicate with a wearable electronic device;
an interactive display screen; and
a processor coupled to the interactive display screen and the communications circuitry, the processor operative to:
manage presentation of pictographs to be displayed on the wearable electronic device, wherein for each pictograph to be displayed on the wearable device, the processor is further operative to:
receive a user selection of a picture; and
receive a start time and an end time to define an activity specific time frame corresponding to the picture, wherein the activity specific time frame corresponding to the picture of each pictograph specifies when the picture should be displayed on the wearable electronic device; and
transmit the picture of each pictograph to the wearable electronic device via the communications circuitry.

12. The electronic device of claim 11, wherein for each pictograph to be displayed on the wearable device, the processor is further operative to:
receive an indication of whether verification of task completion is required;
receive an indication of whether the wearable electronic device should vibrate to alert the existence of the pictograph during the activity specific time frame corresponding to the picture.

13. The electronic device of claim 11, wherein for each pictograph to be displayed on the wearable device, the processor is further operative to:
receive custom entered notes.

14. The electronic device of claim 11, wherein the processor is operative to:
display the picture currently being displayed on the wearable electronic device;
display at least one note associated with the picture currently being displayed on the wearable electronic device.

15. The electronic device of claim 11, wherein the communications circuitry is operative to communicate with a remote server via an Internet connection, wherein the processor is operative to:
exchange data regarding one or more of the plurality of pictographs with the remote server.

16. The electronic device of claim 11, wherein the processor is operative to:
display status information pertaining to each pictograph, wherein the status information comprises a percentage of successful completion of a task associated with a particular pictograph.

17. The electronic device of claim 16, wherein the status information comprises time shown along an x-axis and the percentage of successful completion of a task associated with a particular pictograph shown along a y-axis.

18. The electronic device of claim 11, wherein the processor is operative to:
display a virtual trophy case.

19. The electronic device of claim 18, wherein the virtual trophy cases comprise three categories of success, and wherein when the user of the wearable device accomplishes a task associated with one of the pictographs, that pictograph is displayed in connection with one of the three categories of success.

20. The electronic device of claim 19, wherein any pictograph for which its associated task has not been completed in connection with one of the three categories of success, that particular pictograph is blacked out.

21. The electronic device of claim 11, wherein the processor is operative to transmit, at the start time, the picture of the pictograph corresponding to the activity specific time frame that is currently active to the wearable electronic device via the communications circuitry.
